(19) United States
(12) Patent Application Publication
(10) Pub. No.: US 2015/0112869 A1
(43) Pub. Date: Apr. 23, 2015

(54) Methods and Systems for Use in Online Transactions

(71) Applicant: MASTERCARD INTERNATIONAL INCORPORATED, Purchase, NY (US)

(72) Inventors: Cristian Radu, Beauvechain (BE); Lukas Ekselius, Overijse (BE); Fikret Ates, Namur (BE)

(21) Appl. No.: 14/516,062

(22) Filed: Oct. 16, 2014

(30) Foreign Application Priority Data
Oct. 17, 2013 (GB) 1318411.4

(51) Int. Cl. G06Q 20/36; G06Q 20/38; G06Q 20/10

(52) U.S. Cl. CPC G06Q 20/3674; G06Q 20/10; G06Q 20/382
USPC 705/67; 705/65

(57) ABSTRACT

A method of enabling the creation of a wallet entry in a digital wallet, wherein the wallet entry is for use in completing online transactions. The method comprises associating a local device with a network portal, using the local device to obtain card data relating to a card, encrypting the card data on the local device, and transmitting the encrypted card data from the local device to a remote server by means of the network portal. The remote server is arranged to decrypt the card data and use the card data to create the wallet entry.

### FIELD

The present disclosure relates to methods and systems for use in online transactions. In particular, but not exclusively, this disclosure relates to methods and systems for enabling online purchases through an internet-connectable TV using a payment card.

### BACKGROUND

The rise in the availability of televisions that are connected to the internet, often referred to as “smart TVs”, has opened up the possibility of using a television as an alternative to a personal computer (PC) for making online purchases. Online shopping through a PC, frequently referred to as “e-commerce”, is well established. However, smart TVs are a relatively recent development, and correspondingly online shopping through a smart TV, sometimes referred to as “t-commerce”, is in its relative infancy.

Before t-commerce can develop and become popular, there are several challenges that need to be addressed, for example the security of personal data. PC operating systems include a range of security measures, such as automatic encryption of data, which are designed to ensure that data can be transmitted from the PC to a remote server without being compromised by attacks from malicious third parties. Therefore, a user can input financial details in order to conduct e-commerce transactions, with confidence that their data is protected.

In contrast, software platforms that have been developed for smart TVs have reduced security levels relative to their PC counterparts. This is in part due to the fact that there has simply been less time for such attacks to occur, as smart TVs are a relatively recent development. In addition to this, the content currently available through a smart TV platform is primarily directed to media content such as streaming services or social networking, which are inherently less prone to attack from malicious third parties. Since the development of security systems is driven in part by previous attacks, the lack of a significant attack history for smart TV platforms results in a much less sophisticated security system compared with PC operating systems.

The result of this is that the current security measures that are included with smart TV platforms are inadequate for the purposes of conducting financial transactions. Therefore, improved security measures are required in order to make t-commerce viable.

A second challenge for t-commerce lies in the fact that the way in which a user interacts with a smart TV is quite different to the way in which a user interacts with a PC. PCs are designed to perform a wide range of tasks, some of which are quite complex. Accordingly, input means are typically provided for PCs that are highly versatile and capable of performing a wide range of functions; namely a combination of a mouse and a keyboard. It is therefore a relatively straightforward exercise for the user to go through the various security measures that are implemented in e-commerce systems, including entering multiple passwords, personal identification numbers (PINs) and delivery and billing addresses, along with answering additional security questions.

In contrast, smart TVs are intended as leisure products which are simple to use. Therefore, smart TVs are generally provided with a simple, dedicated remote control which has much more limited functionality than the mouse and keyboard combination. Smart TVs are aimed at a broader demographic, to accommodate people who are less familiar with technology, and who might struggle with operating a PC to conduct conventional e-commerce transactions. As a result, on a smart TV even relatively straightforward web browsing can be quite cumbersome for the user, as they are required to spell out addresses or search terms one letter at a time, using arrows on the remote control to navigate an onscreen keyboard.

Conversely, by virtue of shopping channels and commercials, smart TV offers enhanced marketing possibilities relative to web-browsing on a PC, and therefore the concept of t-commerce is an attractive one to retailers. There is therefore a desire to provide a t-commerce system that meets the challenges outlined above.

### SUMMARY

According to a first aspect of the present disclosure, there is provided a method of enabling the creation of a wallet entry in a digital wallet, where the wallet entry can be used in completing online transactions, the method comprising associating a local device with a network portal, using the local device to obtain card data relating to a card, encrypting the card data using the local device, and transmitting the encrypted card data from the local device to a remote server by means of the network portal, and wherein the remote server is arranged to decrypt the card data and use the card data to create the wallet entry.

The creation of a wallet entry requires a significant amount of sensitive data to be transmitted to the remote server. The card data may include, for example, a card number, an expiry date, and, if applicable, a card security code, along with personal data such as a cardholder name and a billing address. The card data and the personal data are referred to collectively as “card data”. By encrypting the card data on the local device, the method does not depend upon the security provided by the network portal. Accordingly, the method enables the creation of a wallet entry through a network portal having low security levels.

The method may comprise forwarding the card data from the remote server to a card issuer. In this way, the card issuer can authenticate the card data and thereby authorize that the card is genuine and that it can be used to complete transactions.

In one embodiment, enabling creation of the wallet entry may only follow authorization of the card by the card issuer.

For enhanced security, creation of a wallet entry may be enabled only following authorization of the card by a card issuer. Similarly, enabling creation of a wallet entry may be made dependent on the successful completion of a transaction with the payment card using the local device through the network portal. In this embodiment, a wallet entry is created once completion of a transaction with the payment card is authorized by a card issuer. Therefore, to create a wallet entry, the user must complete the first transaction directly using the physical payment card. Subsequent transactions can then be completed using the wallet entry.

The network portal may be an internet-connectable television. Such televisions typically have relatively poor security against attacks from malicious third parties. This is accounted for through the encryption of the card data on the local device, such that raw card data is not exposed to the television and therefore made vulnerable to attack.

The card may be a payment card such as a conventional credit or debit card. Accordingly, the wallet entry may relate to the payment card, and provide a means for completing financial transactions online.

Obtaining the card data may comprise entering data into the local device using an alphanumeric keypad. This may mean entering data which cannot be extracted directly from the card, for example a billing address or a card security code (e.g. a “CVC2” number). The data entered may include a user-specified password, and the method may further include assigning the password to a wallet entry. Use of a password in this way enhances the level of security afforded to the wallet entry that is created. This prevents subsequent modification of any of the card data in the wallet entry or triggering of a payment transaction using the wallet entry by any person other than the legitimate cardholder.

The method may include completing an online transaction using a previously created wallet entry. This provides a fast and convenient way for a user to complete a transaction. For enhanced security, completing a transaction in this way may include using an input device to enter the password associated with the wallet entry, and transmitting the password to the remote server to authenticate use of the previously created wallet entry. To prevent the password from being intercepted by a malicious third party, the method may include converting the password into a keyed-hash message authentication code prior to transmission to the remote server. The password may be combined with a transaction total to create the keyed-hash message authentication code. In this way, a unique authentication code is created for each transaction which cannot be re-used by a malicious third party in subsequent transactions. In a convenient arrangement, the password may be used as a key for creating the keyed-hash message authentication code.

The input device may be a control unit for the network portal. For example, if the network portal is an internet-connected television, the input device could be a remote control device associated with the television. As such, the control unit may operate the network portal remotely.

In one embodiment, the local device is integrated with the control unit to provide a compact and efficient arrangement with few separate components.

According to a second aspect of the present disclosure, there is provided a method of completing an online transaction, comprising associating a local device with an internet-connectable television, using the local device to obtain card data from a card, encrypting the card data on the local device, and transmitting the encrypted card data through the internet-connectable television to a remote server in order to complete the online transaction. As with the first aspect, the card may be a conventional payment card such as a credit or debit card.

Thus, a method is provided for using an internet-connectable television in order to complete online transactions. The use of a television in this way is convenient for people who are less familiar with technology, and who may struggle to use a computer for similar purposes. Furthermore, the method provides additional functionality for the television. As for the method of the first aspect, in the method of the second aspect, the poor security typically provided by an internet-connectable television is accounted for through the encryption of the card data on the local device.

The method may include forwarding the card data from the remote server to a card issuer, and completing the transaction in dependence on receiving authorization from the card issuer. Receiving authorization may entail transmission of an authorization message or code from the card issuer to the remote server.

Upon completion of an online transaction using a method according to the second aspect, creation of a wallet entry can be enabled using a method according to the first aspect. In this way, the first and second aspects of the disclosure overlap such that the process of creating a wallet entry can be combined with completing an initial transaction using the card. This provides an efficient method which does not require any redundant transactions for the purpose of creating the wallet entry.

The method of the first or the second aspect may include connecting the local device to the network portal. The local device may be connected directly using a wired connection, or alternatively, the local device may be connected to the network portal wirelessly. Alternatively, associating the local device with the network portal may entail, for example, integrating the local device with the network portal.

The remote server in the first or second aspect may be an online merchant or a payment service provider. Therefore, these embodiments of the first and second aspects of the disclosure beneficially enable completion of transactions with a wide range of providers.

In either of the methods described above, obtaining the card data may comprise extracting data directly from the card using the local device. For example, the local device may be a card reader which is able to read data from a chip on the card. This provides a convenient means of entering the card data into the local device which minimizes user input.

As with the method of the first aspect, in the method of the second aspect, obtaining the card data may comprise entering data into the local device using an alphanumeric keypad. This may mean entering data which cannot be extracted directly from the card, for example, a billing address. The data entered may include a user-specified password, such as a personal identification number (PIN), which enhances the level of security of the transaction.

In the method of the first or the second aspect, the local device may be a personal card reader, in which case the card may be inserted into the personal card reader.

In either of the above methods, a secure channel may be established between the local device and the remote server using session keys. This enables data to be transmitted securely between the local device and the remote server, effectively bypassing any security systems implemented in the network portal. Since the network portal may have relatively poor security, the secure channel ensures that sensitive data is not vulnerable to exposure to malicious third parties.

According to a third aspect of the present disclosure, there is provided a system for enabling the creation of a wallet entry in a digital wallet, wherein the wallet entry is for use in completing online transactions, and wherein the system comprises a network portal arranged to connect to a network, a local device arranged to associate with the network portal; wherein the local device comprises an input module arranged to obtain card data relating to a card, an encryption module arranged to encrypt the card data, and a transmission module arranged to transmit the encrypted card data from the local device to a remote server by means of the network portal; wherein the remote server is arranged to decrypt the card data and use the card data to create the wallet entry.

As in the first and second aspects of the disclosure, in the system of the third aspect the network portal may be an internet-connectable television.

The input module may comprise an alphanumeric keypad, which enables manual input of data including, for example, a billing address or a user-specified password.

The system may comprise an input device arranged to enable a user to input data. The input device may be a control unit for the network portal. For example, in the case where the network portal is an internet connected television, the control unit may be a remote control for the television. As such, the control unit may be arranged to operate the network portal remotely.

In one embodiment, the local device is integrated with the control unit to provide a compact and efficient arrangement with few separate components.

According to a fourth aspect of the present disclosure, there is provided a system for completing online transactions, wherein the system comprises: an internet-connectable television; a local device arranged to associate with the internet-connectable television, wherein the local device comprises: an input module arranged to obtain card data relating to a card; an encryption module arranged to encrypt the card data; and a transmission module arranged to transmit the encrypted card data from the local device to a remote server by means of the network portal.

The local device of the system of either the third or fourth aspect may be arranged to connect to the network portal. The local device may be connected directly using a wired connection, or alternatively, the local device may be connected to the network portal wirelessly. Alternatively, associating the local device with the network portal may entail, for example, integrating the local device with the network portal.

In either of the above systems, the remote server may be an online merchant or a payment service provider.

The input module of either of the above systems may comprise a card reader arranged to extract data directly from the card. In one embodiment, the local device may be a personal card reader.

The systems described above may be arranged to establish a secure channel between the local device and the remote server using session keys, which provides the same benefits as described above in relation to the methods of the first and second aspects.

It will be appreciated that preferred and/or optional features of the first, second, third and fourth aspects of the disclosure may be incorporated alone or in appropriate combination in any other aspect of the disclosure also.

### DRAWINGS

In order that the present disclosure may be more readily understood, preferred non-limiting embodiments thereof will now be described, by way of example only, with reference to the accompanying drawings, in which:

FIG. 1 is a schematic illustration of an architecture of a t-commerce system according to an embodiment of the disclosure;

FIG. 2 is a diagrammatic illustration of a top-level process for commencing a t-commerce transaction;

FIG. 3 is a diagrammatic illustration of a sub-process for the top-level process in FIG. 2, showing a shopping browsing and selection stage;

FIG. 4 is a diagrammatic illustration of a sub-process for the top-level process in FIG. 2, showing a user selection and registration stage;

FIG. 5 is a diagrammatic illustration of a sub-process for the top-level process in FIG. 2, showing a shopping checkout stage;

FIG. 6 is a diagrammatic illustration of a sub-process for the user selection and registration stage in FIG. 4, showing a card transaction process;

FIG. 7 is a diagrammatic illustration of a sub-process for the card transaction process in FIG. 6, showing a PCR connection verification stage;

FIG. 8 is a diagrammatic illustration of a sub-process for the card transaction process in FIG. 6, showing a secure channel establishment stage;

FIG. 9 is a diagrammatic illustration of a sub-process for the card transaction process in FIG. 6, showing a card prompt stage; and

FIG. 10 is a diagrammatic illustration of a sub-process for the card transaction process in FIG. 6, showing a wallet entry creation stage.

### DETAILED DESCRIPTION

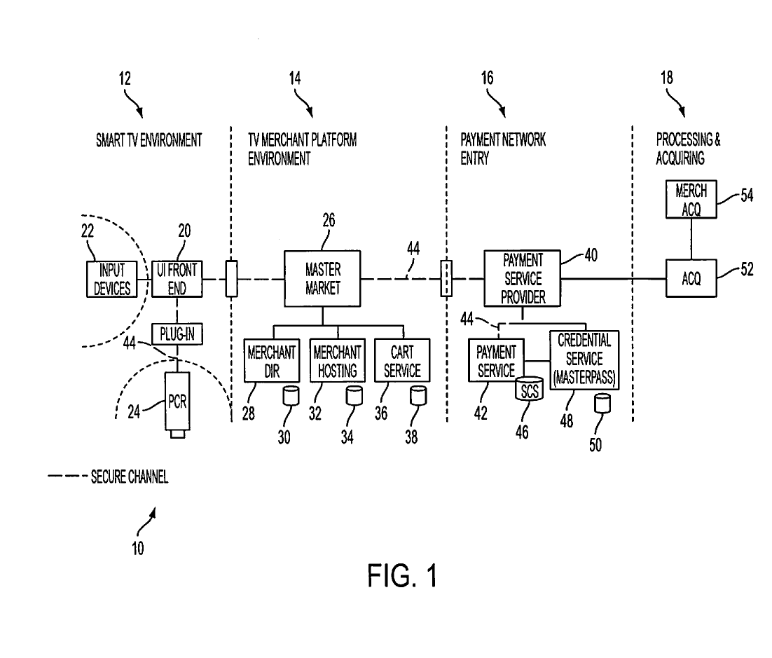

FIG. 1 illustrates an architecture for a t-commerce system 10 which allows a user to use an internet-connectable television, hereafter referred to as a smart TV, to purchase items from an online merchant using a payment card, which may be either a debit card or a credit card. The t-commerce system 10 additionally enables the creation of a wallet entry in a digital wallet, as shall be described.

The system 10 includes four separate software platforms, as designated by the vertical dashed lines in FIG. 1. Each platform is connected to a common network, which in this embodiment is the world-wide-web, through which the platforms communicate with one another. The four platforms are: a smart TV platform 12; a merchant platform 14; a payment network 16; and a processing and acquiring platform 18. Each platform 12, 14, 16, 18 includes several local components, as will be explained below. As illustrated in FIG. 1, the smart TV platform 12 communicates with the merchant platform 14, which in this embodiment is located on the world-wide-web. In this way, the smart TV acts as a network portal to allow access to the world-wide-web for any peripheral devices connected to the smart TV. The merchant platform 14 communicates with the payment entry network 16, which in turn communicates with the processing and acquiring platform 18.

The smart TV platform 12 includes a user interface (UI) 20 which displays information to the user, and with which the user can interact in order to use the t-commerce system 10, for example, to make purchase selections. An input device 22, for example, a conventional television remote control, is provided to enable the user to drive the user interface 20. The input device 22 typically communicates with the smart TV wirelessly by means of infra-red radiation. A personal card reader (PCR) 24 is provided, which is used to make secure card payments through the smart TV platform 12. The PCR 24 connects directly to the smart TV, using either a wired connection, for example, using a USB interface, or a wireless connection, for example using Bluetooth®. The PCR 24 includes an alphanumeric keypad, a display, and a slot arranged to accept a “Chip and PIN” type payment card. When a payment card is inserted into the slot of the PCR 24, the PCR 24 extracts data from the chip of the card, including a card number and an expiry date. The alphanumeric keypad allows the user to enter additional data related to the payment card, for example, a CVC2 code and a billing address, in addition to creating a password to be associated with the payment card. This data is encrypted by the PCR 24, and is then sent through the smart TV platform 12 to the payment network 16. The payment card data is used to create a new entry in a digital wallet, as will be explained in further detail below. The display presents appropriate information to the user during the operation of the PCR 24.

The merchant platform 14 hosts several online merchants in a single master market 26. The UI 20 of the smart TV platform 12 communicates directly with the master market 26, such that the user can browse the master market 26 to see the products offered by each merchant, and then select items to purchase. To enable this, the master market 26 includes underlying components which extract the necessary data and services from the online merchants. These components include: a merchant directory 28, which lists the merchants that connect to the master market 26 and which includes a merchant database 30 which holds data relating to each merchant's products and prices; a merchant hosting module 32 and an associated hosting database 34, which establishes communication between the merchants and the master market 26; and a cart service module 36, which is used to allow the user to create an online shopping cart in a similar manner to conventional e-commerce systems, with user selections stored in an associated cart database 38.

When a user has finished making selections and wishes to complete a transaction, the master market 26 communicates with a payment service provider (PSP) 40 which is hosted on the payment network 16. The PSP 40 facilitates the transfer of funds between banks and the merchants connected to the master market 26. The PSP 40 connects to several different acquiring banks through the processing and acquiring platform 18. Since each acquiring bank can obtain monetary funds from a wide range of banks, the PSP 40 can enable the merchants to accept a variety of electronic payments offered by the user. In this embodiment, the payment card is used to complete the transaction.

As noted above, the smart TV platform 12 is inherently less secure than a PC operating system, and therefore the smart TV platform 12 is not a suitable platform from which to transmit financial or payment card data. For this reason, the PSP 40 uses a payment service module 42 to establish a temporary secure channel 44 between the PSP 40 and the PCR 24. The secure channel 44 remains in place during periods in which sensitive data is transferred between the PCR 24 and the PSP 40. In some circumstances, the secure channel 44 is only used during a registration process in which the user transmits payment card details to the PSP 40, while in other circumstances the secure channel 44 may remain in place until the PCR 24 is disconnected or until the smart TV is powered off. Data is encrypted prior to transmission along the secure channel 44, such that the payment card data is not visible to the smart TV platform 12 or the master market 26. Therefore, the secure channel 44 does not depend on the security of the smart TV platform 12 and the master market 26. In this way, the problem presented by the insufficient security provided by the smart TV platform 12 is overcome.

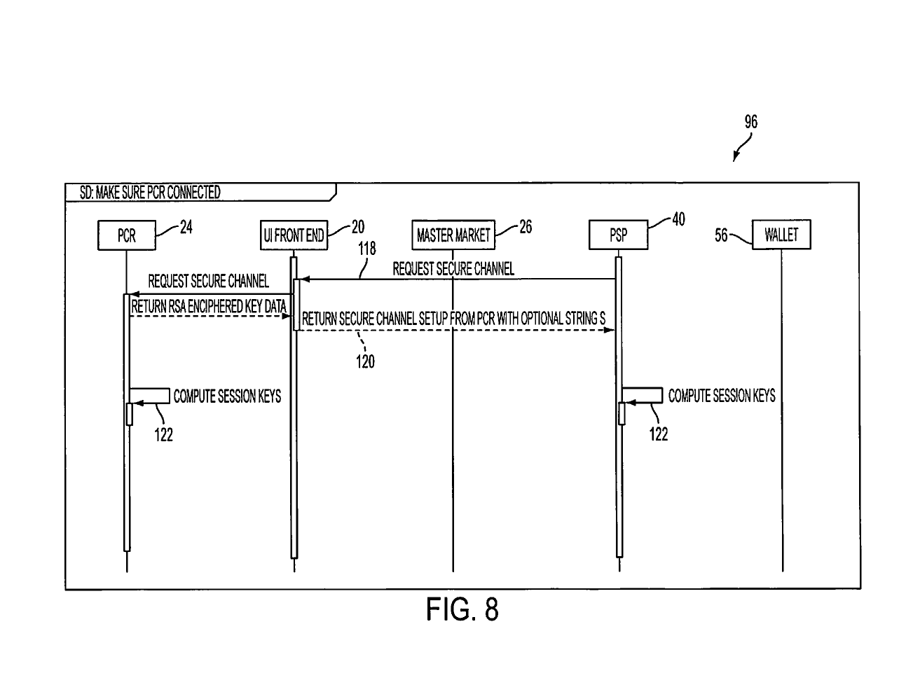

The payment service module 42 is hosted on a remote server, and includes a secure channel server 46, which contains all of the data which is required to establish and maintain the secure channel 44. Some of this data relates to session keys, as will be familiar to the skilled reader. The PCR 24 is pre-programmed with a set of public keys, and the PSP 40 holds a set of corresponding private keys. The PSP 40 selects a key index which identifies a pair of public and private keys to use for each instance of the secure channel 44, and sends a message to the PCR 24 to indicate which key index to use. The PCR 24 generates session keys to be used by the secure channel 44 for converting data into message authentication code (MAC) format and for bulk encryption. The public key indicated by the PSP 40 is used by the PCR 24 to encrypt outgoing data containing the session keys, and the corresponding private key is used by the PSP 40 to decrypt data received from the PCR 24 and to retrieve the appropriate session keys for use by the secure channel server 46 to synchronize on the secure channel 44 with the PCR 24. The process for establishing the secure channel 44 is described in further detail below with reference to FIG. 8.

While it is possible for each transaction to be completed by inserting a payment card into the PCR 24 on each occasion, as noted above, in this embodiment when a first transaction is successfully completed, a wallet entry relating to the payment card is created in a digital wallet. This allows subsequent transactions to be completed using just the wallet entry, without the need to provide the payment card. This arrangement is beneficial to the user, as it allows them to register one or more payment cards initially, and thereafter simply select a registered card to make subsequent purchases, without the need to find the physical card or to use the PCR 24 again. In this way, the system 10 addresses the abovementioned need to provide an arrangement which is simple to use, and as such is appropriate to the way in which users tend to interact with a smart TV.

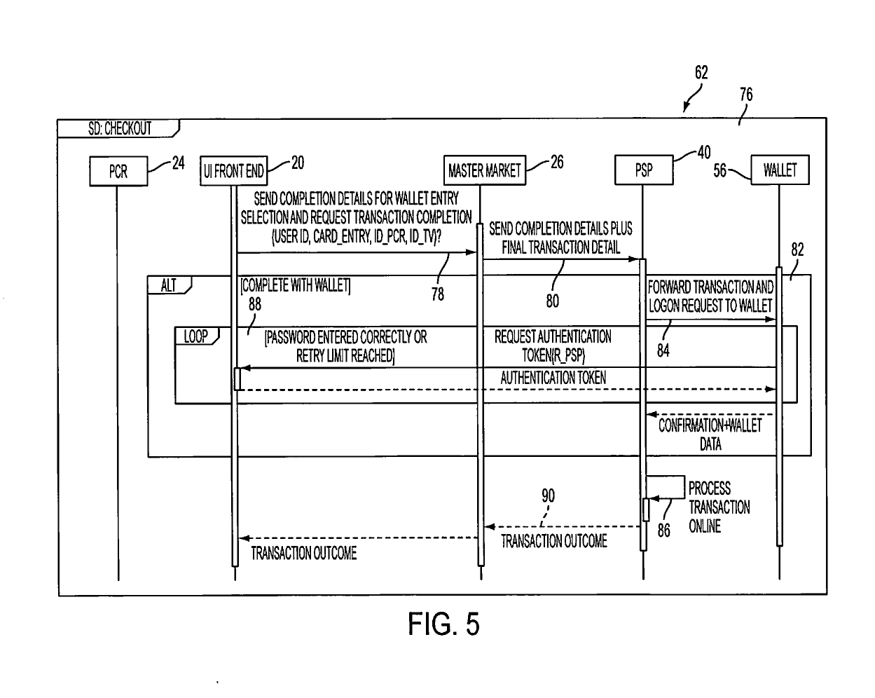

The digital wallet is contained on a credential service module 48, which has a wallet database 50 in which payment card details are stored. Incoming encrypted payment card data from the PCR 24 through the secure channel 44 is decrypted by the PSP 40 and forwarded to the credential service module 48. The credential service module 48 uses the decrypted data to create a new wallet entry which is stored in the wallet database 50. The payment card data includes all of the information that is required in order to allow future transactions to be completed without access to the physical payment card. This includes the card number, the expiry date, the CVC2 code, and the billing address. In addition to this, as noted above, the payment card data includes a password which has been created by the user which is to be associated with the new wallet entry. Accordingly, the password is stored with the wallet entry in the wallet database 50. Subsequently, when a request is made to complete a transaction using the wallet entry, the credential service module 48 returns a request for the password and ensures that the correct password is provided before validating the transaction. The process for authenticating transactions is described in further detail below with reference to FIG. 5.

Once a payment card or wallet entry has been authenticated by the PSP 40, the PSP 40 then communicates with an acquisition module 52 hosted on the processing and acquiring platform 18, in order to obtain the funds required to complete the transaction. The acquisition module 52 connects to a merchant acquirer 54, which is a bank that processes the payment card in order to complete the transaction with the merchant. To this end, the merchant acquirer 54 communicates with the card-issuing bank, and transfers funds from the card-issuing bank to a merchant account, which is a line of credit between the merchant and the merchant acquirer 54.

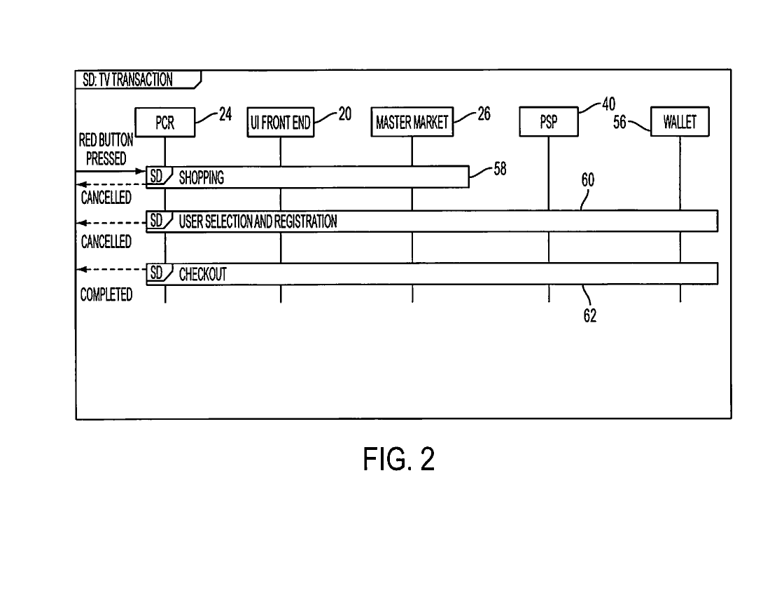

Turning now to FIG. 2, there is shown a top-level process for using the t-commerce system of FIG. 1 to browse the online master market and to make purchasing selections. FIG. 2 shows the five key components of the system, namely: the PCR 24; the UI 20; the master market 26; the PSP 40; and the wallet 56, which is a combination of the credential service module 48 and the wallet database 50 stored on the credential service module 48, as shown in FIG. 1.

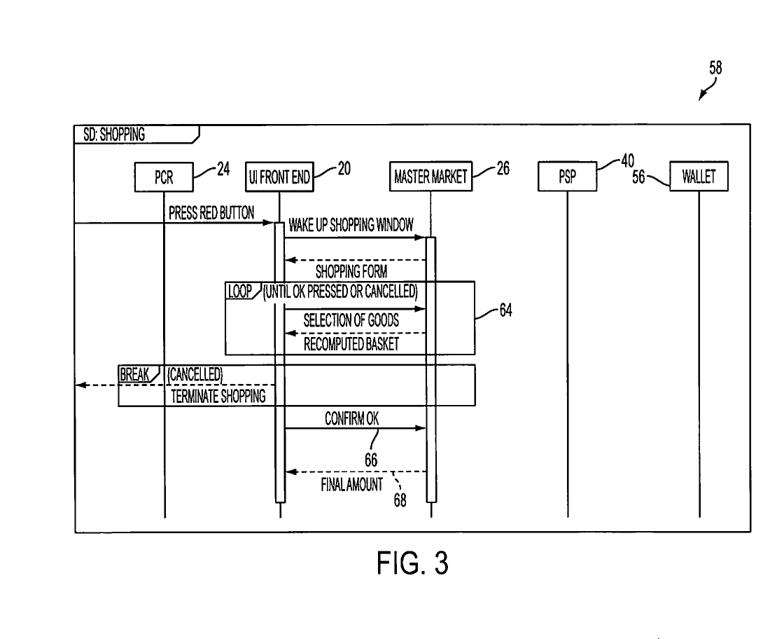

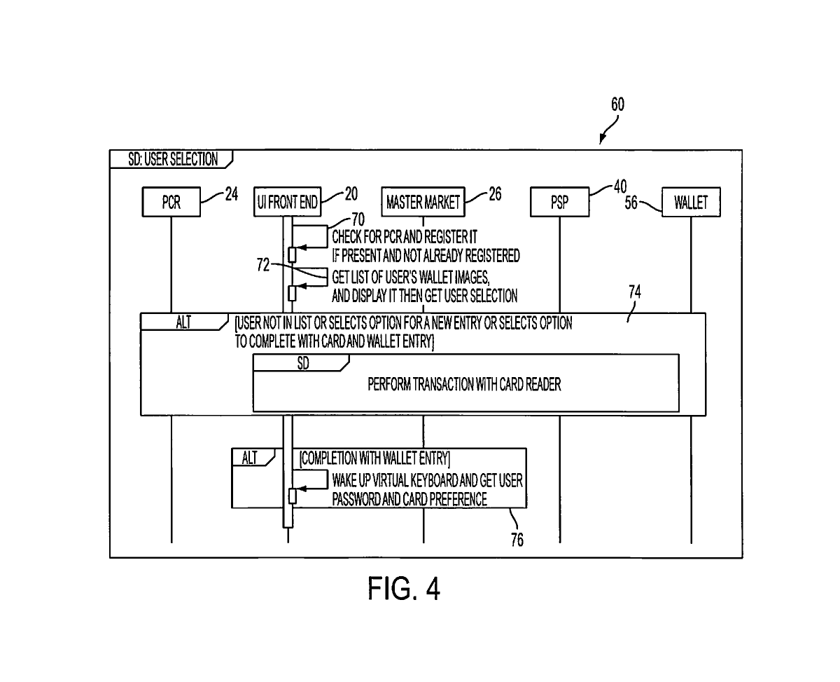

FIG. 2 includes three boxes representing, respectively, three stages involved in making purchase selections. Each of the three boxes indicates which of the five components is involved in the respective stage. Each of the boxes corresponds to a later figure, in which the steps involved in the respective stage are outlined. The uppermost box relates to a shopping stage 58, which is shown in more detail in FIG. 3. As FIG. 2 illustrates, the shopping stage 58 involves the UI 20 and the master market 26. The middle box relates to a user selection and registration stage 60, which follows the shopping stage 58, and is illustrated in more detail in FIG. 4. As shown in FIG. 2, the user selection and registration stage 60 involves all five components of the t-commerce system listed above. The lowermost box relates to a checkout stage 62, which follows the user selection and registration stage 60, and which is illustrated more clearly in FIG. 5 for the case where a user makes use of a wallet entry to complete the t-commerce transaction. The checkout stage 62 involves the UI 20, the master market 26, the PSP 40 and the wallet 56.

As shown in FIG. 2, the shopping stage 58 can be initiated by the user by pressing a red button on the remote control for the smart TV. The remote control is also used to navigate each of the stages 58, 60, 62 as the user progresses. Furthermore, the user has the option to cancel any of the three stages 58, 60, 62, for example by pressing a “back” button on the remote control. Therefore, the user is not required to make a purchase after initiating the shopping stage 58. If a shopping session is ended before completing the checkout stage 62, the user has the option to save any selections made so that they can return to the session at a later time.

With reference to FIG. 3, the shopping stage 58 is shown in more detail. As shown in FIG. 3, when the red button is pressed to initiate the shopping stage 58, the UI 20 automatically communicates with the master market 26 by outputting a “wake-up” signal to open or “wake up” a shopping window. The master market 26 returns a shopping form to the UI 20, which provides the user, through the UI 20, with purchasing options, pricing data, offers, and other data that allows the UI 20 to create one or more shopping screens that present all possible shopping options to the user.

Once the shopping screens have been created, the shopping stage 58 enters a loop 64 in which the user navigates between the shopping screens on the UI 20 using the remote control in order to browse the items offered, and to make selections. Each time the user makes a selection, the selected item is added to a basket of a type such as those used in conventional e-commerce websites. When the user has made all of the selections that they wish to make, they can then confirm, at Step 66, that the shopping stage 58 is complete, for example, by using the remote control to navigate to a “proceed to checkout” button displayed on the smart TV by the UI 20.

Once the user has confirmed, at Step 66, that they have completed making their selections, the UI 20 sends a completion signal to the master market 26. The master market 26 then returns, at Step 68, a final amount that is owed by the user in return for the selected items, which is hereafter referred to as the transaction total. The shopping stage 68 then finishes, and the user selection and registration stage 60 is initiated.

FIG. 4 illustrates the user selection and registration stage 60, in which the user registers with a new account associated with the smart TV and PCR 24, in order to complete the transaction. If the user has previously registered, they can use their account to complete the transaction, or they can create a new account if desired. Each account can have several wallet entries stored in it, each entry corresponding to a different payment card. Once registered with an account, there are two options available to the user for completing a transaction, which are to pay directly with a payment card using the PCR 24, or to pay using a previously created digital wallet entry.

Paying directly using a payment card inserted into the PCR 24 is the most secure of these options. If paying directly with the payment card, a new wallet entry can be created with which to complete subsequent transactions. This means that the payment card is not required again the next time the user wishes to complete a transaction. In this way, future transactions can be completed more quickly by using the wallet entry. If a wallet entry is not created, the payment card will be required the next time the user wishes to complete a transaction.

By combining wallet entry creation with completion of a transaction with the physical payment card, the process is streamlined, thereby saving time for the user. However, the skilled reader will appreciate that in other embodiments, a separate wallet entry creation process may be implemented, such that a user can create a new wallet entry at any time.

If the user wishes to register a new account, create a new wallet entry, or pay directly with a payment card, the PCR 24 must be connected to the smart TV. Accordingly, as shown in FIG. 4, when the user selection and registration stage 60 commences, the UI 20 first checks, at Step 70, whether the PCR 24 is connected to the smart TV.

If the PCR 24 is detected by the UI 20, the UI 20 checks whether the PCR 24 is registered locally on the smart TV. If the PCR 24 has been registered previously on the smart TV, a specific device ID that is unique to the PCR 24 is stored in a local memory of the smart TV. Each time a PCR 24 is detected, the UI 20 checks the device ID of the PCR 24 against those stored in the local memory. If the device ID of the PCR 24 is not found in the local memory, the UI 20 registers the PCR 24 on the smart TV by adding the device ID to the local memory.

Once the PCR 24 is recognized or registered locally, the UI 20 then checks, at Step 72, for any users that have been registered locally on the smart TV. For each registered user, a corresponding user ID is stored in the local memory of the smart TV. Each locally stored user ID is retrieved and presented to the user, and the user selects a user ID with which to continue the transaction. The UI 20 also offers the user the option to create a new user ID. A personal identification number (PIN) may be associated with each user ID in order to prevent misuse.

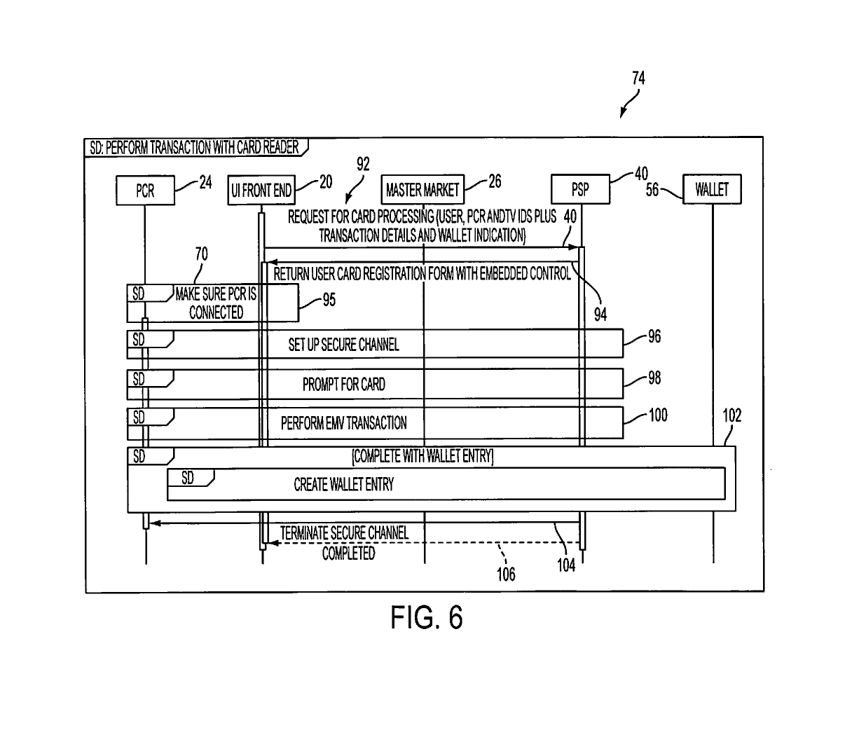

Once both the PCR 24 and the user ID have been recognized, the user can complete the transaction by paying with a payment card directly using the PCR 24. The UI 20 offers the user the option to create a new wallet entry when the transaction completes. Once the user selects whether to create a wallet entry using the remote control, a card transaction process 74 is initiated. The card transaction process 74 is described in more detail later with reference to FIG. 6.

As well as being registered locally, both the PCR 24 and the user ID need to be registered with the wallet 56. Therefore, if the UI 20 finds that the PCR 24 is connected and is not registered with the wallet 56, the UI 20 transmits the device ID of the PCR 24 to the wallet 56. Similarly, the user ID is also transmitted if it is not registered on the wallet 56. The wallet 56 recognizes the smart TV from which the device ID and/or the user ID have been transmitted by virtue of a TV ID which is attached to the data. Once the wallet 56 has both the device ID of the PCR 24 and a user ID, an account is created on the wallet 56 which associates the user with the smart TV and the PCR 24. The account is identified by means of the user ID, and is used to create wallet entries and complete transactions.

If the UI 20 detects that the PCR 24 is not connected and the user is not already registered, the UI 20 prompts the user to connect the PCR 24 to the smart TV. The UI 20 continues to monitor for the presence of the PCR 24 until a connection is made, or until the user cancels the transaction using the remote control.

Alternatively, if the user and smart TV are already registered, and the user has created at least one wallet entry in the wallet 56, the PCR 24 does not need to be connected to the smart TV. Instead, the user can complete the transaction in the checkout stage 62 using a wallet payment process 76, which is described in detail below with reference to FIG. 5.

Returning to FIG. 4, for a registered user, if the PCR 24 is not connected, the UI 20 prompts the user either to connect the PCR 24 to the smart TV, or to complete the transaction using a previously created wallet entry. If the user chooses to use a wallet entry to complete the transaction, the UI 20 then recovers, at Step 74, a list of wallet images relating to the user. The wallet images are stored in the local memory of the smart TV, and each image corresponds to a wallet entry which has been created in the wallet 56. The wallet image serves only to identify the wallet entry to which it relates; no sensitive payment card data is stored in the local memory of the smart TV. The wallet images have been created by the UI 20 previously as part of a card transaction process 74. It is noted that the UI 20 only has access to images of the wallet entries, and not to the wallet entries themselves, which are stored remotely in the digital wallet 56. In this way, the payment card details contained in the wallet entries are not exposed to the relatively low level security of the UI 20.

Once the wallet images have been retrieved, they are then displayed to the user. The user can then select a wallet entry with which to complete the t-commerce transaction using the wallet payment process 76.

Each wallet entry has an associated password which is created by the user when setting up the wallet entry. The user can therefore complete the transaction by selecting a wallet entry and entering the associated password using the remote control. For this purpose, the UI 20 displays a virtual keyboard on the smart TV, which the user can navigate using the remote control, so as to spell out the password.

FIG. 5 shows the wallet payment process 76 in more detail. The process 76 begins once the user selects a wallet entry for completing the transaction in the user selection and registration stage 60. The wallet payment process 76 commences with the UI 20 outputting a completion request and sending, at Step 78, completion details with which to complete the t-commerce transaction to the master market 26. The completion details include the user ID, the device ID of the PCR 24, and the TV ID of the smart TV associated with the user ID, along with the wallet entry that has been selected by the user.

Once the master market 26 receives the request to complete together with the completion details from the UI 20, the completion details are forwarded, at Step 80, to the PSP 40, along with the transaction total, so as to authenticate the user. The PSP 40 receives this information, and then initiates a wallet entry verification process 82 in order to validate payment using the selected wallet entry in order to clear funds to complete the transaction with the master market 26.

The wallet entry verification process 82 is initiated when the PSP 40 forwards a transaction and logon request to the digital wallet 56, at Step 84. If the request is successful, the wallet 56 identifies the wallet entry that has been selected, and the PSP 40 extracts some details from the wallet entry that are relevant to the master market 26, for example, the delivery address. These details are then returned to the master market 26. The wallet 56 then retrieves the password associated with the wallet entry. If the wallet entry cannot be found within the wallet 56, an error is returned.

Once the password has been identified, the wallet 56 then outputs a password request to request the password from the user. This is implemented by sending a request to the UI 20 using conventional challenge-response protocol. As noted above, the user then enters the password into the UI 20 using the remote control. The UI 20 then combines the entered password with another value, in this embodiment the transaction amount, in order to create a message authentication code (MAC), as will be familiar to the skilled reader. In this embodiment, the MAC code is created according to a “keyed-hash message authentication code” (HMAC) construction, in which the data is compressed using a secret key, for enhanced protection. The password is used as the secret key, so as to prevent a third party from accessing the key through the UI 20. The MAC which is created acts as an authentication token, which takes the following form:

LS₄[HMAC[password,s∥amount∥currency]]∥amount∥currency

Where “LS₄” represents the least significant 4 bytes; “password” is the password entered by the user; “s” is a unique random number sent by the PSP 40 in a request for authentication of the user during establishment of a prior session of the secure channel, which is described below; “amount” is the transaction amount; and “currency” is the currency in which the transaction is to be completed.

The authentication token is then returned to the wallet 56, which compares the password contained in the authentication token with the password associated with the wallet entry. Since the authentication token is constructed from a combination of the password associated with the wallet entry and the transaction total, the MAC created is unique to the transaction. Therefore, in subsequent transactions, the MAC used to verify the wallet entry payment will be different. The MAC is created in such a way that it is not possible to determine which components relate to the password and which components relate to other data, in this case the transaction amount. Accordingly, it is not possible for a third party to fraudulently use the wallet entry simply by intercepting a MAC and re-using it.

Since the wallet 56 has access to the password, the wallet 56 can use the password to authenticate the MAC received from the UI 20. This is achieved by re-computing the MAC using the same parameters, namely those included in the above equation, and checking the computed value against the received value. If the two values match, the MAC is authenticated. This is possible because the wallet 56 also has access to both the transaction total and the password for the user's account.

If the MAC is authenticated, the wallet 56 sends an authentication message to the PSP 40. The PSP 40 then completes, at Step 86, the transaction by obtaining the required funds from the acquisition module and forwarding them to the master market 26. In this embodiment, the transaction is a mail order/telephone order (MO/TO) type transaction as will be familiar to the skilled reader, in which only a primary account number (“PAN”, i.e. the card number), the card expiration date and the CVC2 code are used. These details are stored within the wallet entry in the digital wallet 56, as will be described in detail later.

If the password is incorrect, the wallet 56 sends a further password request to the UI 20, allowing the user another chance to enter the correct password. This process is repeated in a loop 88 a pre-determined number of times, until either the correct password is entered or an attempt limit is reached. If the user exhausts the permitted number of attempts allowed to enter the correct password, typically three, the UI 20 will then deny the user the option to use the selected wallet entry. The UI 20 then offers the user the option to complete the transaction using one of the alternative payment methods described above. Alternatively, if payment with a wallet entry is unsuccessful, the user can cancel the transaction as described previously.

Once the transaction completes, the outcome is forwarded, at Step 90, to the master market 26 as payment guarantee, and further on to the UI 20, to inform the user.

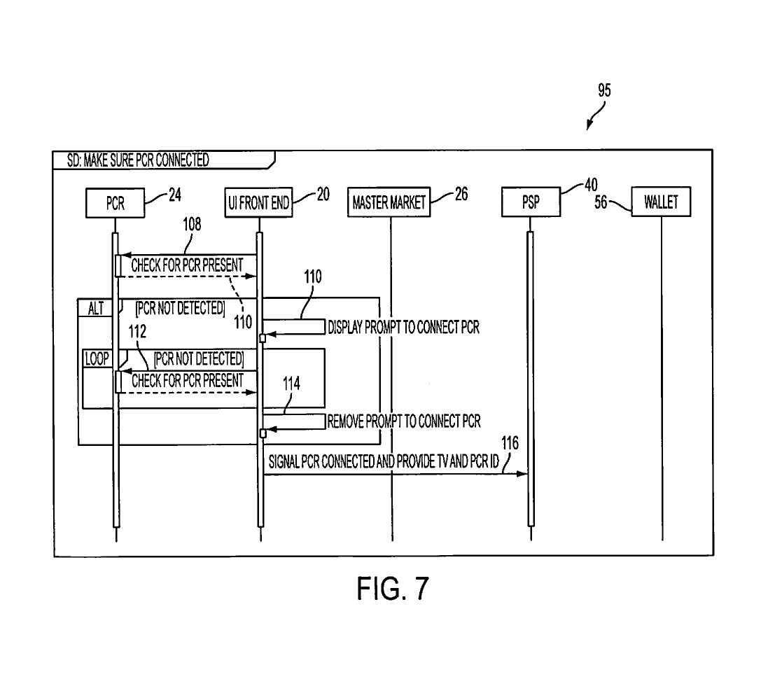

Turning now to FIG. 6, as noted above, a card transaction process 74 is shown. FIG. 6 provides an overview of the card transaction process 74, with FIGS. 7 to 10 illustrating elements of the process 74 in more detail.

As shown in FIG. 6, the card transaction process 74 starts when the UI 20 outputs, at Step 92, a request for a card processing stage through the PSP 40. This occurs when the user has finished browsing and making shopping selections, and wishes to complete the t-commerce transaction as described previously. The PSP 40 receives the request from the UI 20, and returns, at Step 94, a user card registration form with embedded control. The card registration form defines the information that needs to be extracted from the payment card in order to create a new wallet entry in the wallet 56. Once the card registration form has been received, the UI 20 checks whether the PCR 24 is connected to the smart TV, which corresponds to checking Step 70 of the user selection and registration stage 60 shown in FIG. 4. A PCR connection verification process 95 for checking whether the PCR 24 is connected is shown in more detail in FIG. 7.

Returning to FIG. 6, once the UI 20 has established that the PCR 24 is connected to the smart TV, a secure channel establishment process 96 is performed to establish a new session of the secure channel 44 between the PCR 24 and the PSP 40. As noted previously, the secure channel 44 effectively bypasses the UI 20, as well as the master market 26. In this way, payment card data sent through the secure channel 44 is not vulnerable to exposure to third parties as a consequence of the relatively low level security provided by the UI 20. As such, the establishment of the secure channel 44 provides a secure and reliable means for a user to create a wallet entry in the wallet 56 using the UI 20 of the smart TV. The process for setting up the secure channel 44 is described in more detail below with reference to FIG. 8.

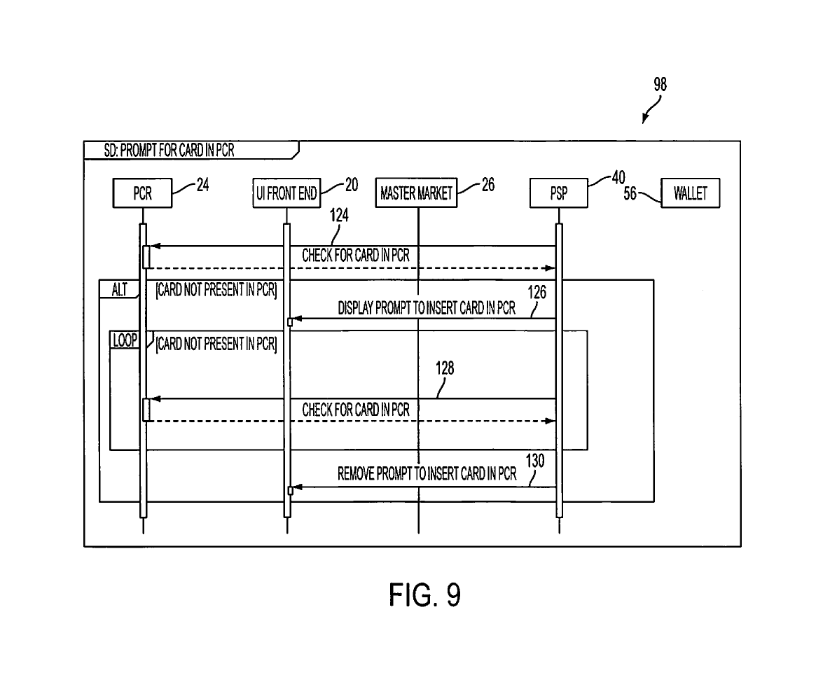

Once the secure channel 44 has been established, a card prompt process 98 is conducted, in which the user is prompted through the UI 20 to insert a payment card into the PCR 24 to be used to complete a transaction and create a new wallet entry. Alternatively, the user can complete the transaction directly using the payment card, without creating a wallet entry. The card prompt process 98 is described in more detail below with reference to FIG. 9.

Once the card prompt process 98 is completed and a payment card has been placed into the PCR 24, a standard Europay®, Mastercard® and Visa® (EMV) transaction 100 can be performed with the PSP 40 through the secure channel 44. In this way, the payment card can be used to pay for the goods selected by the user without the need to set up a wallet entry.

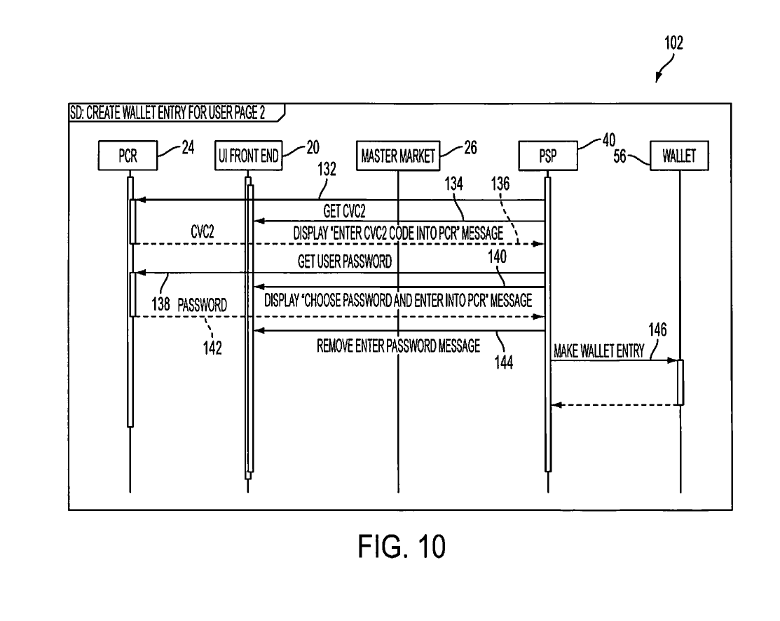

However, if the user wishes to create a new wallet entry, which allows for a faster and more convenient checkout process 62 in subsequent transactions, a wallet entry creation process 102 is then performed. The wallet entry creation process 102 is described in more detail below with reference to FIG. 10.

Once the wallet entry creation process 102 is completed, the PSP 40 terminates, at Step 104, the secure channel 44, and sends, at Step 106, an indication to the UI 20 that the card transaction process 74 has completed.

With reference to FIG. 7, the PCR connection verification process 95 is shown. The UI 20 starts the process 95 by checking, at Step 108, whether the PCR 24 is connected to the smart TV. If the UI 20 does not detect the PCR 24, the UI 20 then displays, at Step 110, a prompt to the user. If the user has registered previously and created a wallet entry, the user is prompted to either connect the PCR 24, or to complete the transaction using the previously created wallet entry, as described previously. If the user has not yet created any wallet entries, they are prompted to connect the PCR 24. If the user selects to connect the PCR 24, or if the user has not created any wallet entries previously, the UI 20 then continues to monitor, at Step 112, for the presence of the PCR 24. Once the PCR 24 is detected, the UI 20 removes, at Step 114, the prompt. The PCR connection verification process 95 then completes by outputting, at Step 116, a signal to the PSP 40 that the PCR 24 is connected, and provides identification details for the smart TV and PCR 24. The identification details are used to register the smart TV and PCR 24 with the PSP 40 and create a user ID if this is the first occasion that the smart TV has been used to conduct a t-commerce transaction. Alternatively, if this is not the first occasion that the smart TV has been used for a t-commerce transaction, the PSP 40 uses the identification details to identify the correct user ID for the purposes of completing the transaction.

Once the PCR connection verification process 95 completes, the secure channel establishment process 96 is performed, which is now described with reference to FIG. 8.

In this embodiment, the secure channel 44 is defined by a data pathway with encryption and decryption of data at either end. Data is encrypted in the PCR 24 prior to entering the secure channel 44, and decrypted by the PSP 40 when leaving the secure channel 44. Conventional data origin authentication and data integrity services are also implemented with a MAC mechanism in the encryption process. Since the secure channel 44 is established between the PCR 24 and the PSP 40, payment card data passing through the UI 20 is always encrypted. In this way, the low-level security provided by the UI 20 is accounted for, in that a third party accessing the UI 20 can only obtain encrypted data, which is of no use to them. Therefore, the user's personal data is protected.

The encryption is conducted using standard protocols, for example “RSA encryption”, which is a public-key encryption method that will be familiar to the skilled reader. This form of encryption makes use of an encryption key (or “public” key) with which data is encrypted at the point of transmission prior to sending, and a corresponding decryption key (or “private” key) at the point of reception. Data encrypted using a particular encryption key can only be decrypted in a reasonable amount of time using the corresponding decryption key. For this reason, the PCR 24 is pre-programmed with a set of encryption keys, and the PSP 40 holds a set of corresponding decryption keys.

Once the PSP 40 has been notified that the PCR 24 is connected at the end of the PCR connection verification process 95, the secure channel establishment process 96 begins with the PSP 40 sending, at Step 118, a request to the PCR 24 to establish a new session of the secure channel 44. The request is sent through the UI 20.

The request to establish the secure channel 44 contains an index which indicates which encryption key the PCR 24 should use for the new session of the secure channel 44. By changing the encryption keys that are used between different sessions of the secure channel 44, the level of protection accorded to the user's data is further enhanced. Although the request is not encrypted, and as such is vulnerable to interception by malicious third parties, no sensitive information is contained in the request; the request simply indicates that a secure channel 44 should be established, and references an encryption key to use. Without foreknowledge of the encryption keys, this information is meaningless to a third-party.

The request further includes a first random number that has been generated by the PSP 40. Once the PCR 24 receives the request and determines from the index which encryption key from within the set provided should be used, the PCR 24 creates a second random number. The PCR 24 then uses a conventional Optimal Asymmetric Encryption Padding algorithm to create an RSA digital envelope that includes both the first and second random numbers, which is returned to the PSP 40, at Step 120. The PSP 40 then decrypts the digital envelope in order to identify the second random number, using the first random number as a check that the envelope has been correctly decrypted. The second random number is then used by the PSP 40 in combination with the selected encryption key to generate a unique session key for the current operation. The PCR 24 also generates a session key in the same way, and thus the PCR 24 and PSP 40 are synchronized on the same session key (as indicated at Steps 122). The session keys are used in the place of the encryption keys, and add an additional layer of protection on top of the standard RSA encryption process. Accordingly, in each session a unique session key is generated, along with a unique MAC.

Once the session keys have been established, the secure channel establishment process 96 is completed. The card prompt process 98 then begins, which is now described with reference to FIG. 9. The card prompt process 98 commences with the PSP 40 checking, at Step 124, for the presence of a card in the PCR 24. If the PSP 40 finds that a card is present in the PCR 24, the card prompt process 98 finishes, and the card transaction process 74 moves on to complete an EMV transaction 100, or to initiate the wallet entry creation process 102, depending on the user's selection.

Alternatively, if it is found that the PCR 24 does not contain a payment card, the PSP 40 sends, at Step 126, a prompt to the UI 20 which is displayed to the user to instruct them to insert a payment card into the PCR 24. The PSP 40 then monitors, at Step 128, for the presence of a payment card in the PCR 24. Once a payment card is detected, the PSP 40 then removes, at Step 130, the prompt from the UI 20. The card prompt process 98 finishes, and as above the card transaction process 74 moves on to complete an EMV transaction 100, or to initiate the wallet entry creation process 102, depending on the user's selection.

Referring now to FIG. 10, the wallet entry creation process 102 commences with the PCR 24 automatically extracting data directly from the payment card that has been inserted. The data extracted includes the card number and expiry date. This data is then encrypted by the PCR 24 using a session key, and sent through the secure channel 44 to the PSP 40. The data is then decrypted by the PSP 40. The PSP 40 then sends, at Step 132, a prompt to the PCR 24 to obtain the payment card's CVC2 code. The PSP 40 simultaneously sends, at Step 134, a prompt to the user to enter the CVC2 code into the PCR 24, which is displayed to the user by the UI 20. The user then enters the CVC2 code using the alphanumeric keypad of the PCR 24. The CVC2 code is then returned, at Step 136, to the PSP 40 through the secure channel 44.

Once the PSP 40 has obtained the CVC2 code, the PSP 40 then obtains further details such as the billing address and the cardholder's name. At this point, the PSP 40 has all of the data that is required for the purpose of creating a new wallet entry in the wallet 56, which has been referred to throughout this description as the payment card data. This data can then be later transmitted to a card issuing bank, through an acquirer on the processing and acquiring platform 18, which then authenticates the payment card data in order to complete a transaction. It is noted that the wallet entry is created only after the payment card has been authenticated by the card issuing bank and the initial transaction has completed.

The PSP 40 then outputs, at Step 138, an instruction to the PCR 24 to obtain a password to be associated with the new wallet entry. Concurrently, the PSP 40 outputs, at Step 140, a prompt to the user to enter a password, which is displayed to the user by the UI 20. The user then enters a password of their choice using the alphanumeric keypad of the PCR 24. The password is returned, at Step 142, to the PSP 40 through the secure channel 44. The PSP 40 then removes, at Step 144, the prompt to enter a password.

The PSP 40 then compiles the payment card data with the password and uses the information to create, at Step 146, a new wallet entry in the wallet 56. The wallet entry creation process 102 is then completed, which also completes the card transaction process 74.

The new wallet entry is ready for the user to use in completing t-commerce transactions. As described previously, once the wallet entry is created, the user can complete transactions simply by selecting the wallet entry and entering the associated password using the remote control; the PCR 24 is not required for future transactions if the wallet entry is used.

It will be appreciated by a person skilled in the art that the disclosure could be modified to take many alternative forms to that described herein, without departing from the scope of the appended claims.

For example, in another embodiment, the PCR may be combined with the remote control of the smart TV to form a single integrated device. In a further embodiment, the PCR may be integrated into the smart TV itself, in which case the smart TV may implement a touchscreen interface in order to enable manual input of card data.

It should be appreciated that the functions described herein, in some embodiments, may be described in computer executable instructions stored on a computer readable media (e.g., in a physical, tangible memory, etc.), and executable by one or more processors. The computer readable media is a non-transitory computer readable storage medium. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

It should also be appreciated that one or more aspects of the present disclosure transform a general-purpose computing device into a special-purpose computing device when configured to perform the functions, methods, and/or processes described herein.

With that said, exemplary embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

The foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A method of enabling the creation of a wallet entry in a digital wallet, wherein the wallet entry is for use in completing online transactions, and wherein the method comprises:
associating a local device with a network portal;
using the local device to obtain card data relating to a card;
encrypting the card data on the local device; and
transmitting the encrypted card data from the local device to a remote server by means of the network portal, wherein the remote server is arranged to decrypt the card data and use the card data to create the wallet entry.

2. The method according to claim 1, comprising forwarding the card data from the remote server to a card issuer to authorize the card for a transaction.

3. The method according to claim 2, comprising enabling creation of the wallet entry only following authorization of the card by the card issuer.

4. The method according to claim 3, comprising enabling creation of the wallet entry only following completion of the transaction with the authorized card.

5. The method according to claim 1, wherein the network portal is an internet-connectable television.

6. The method according to claim 1, wherein obtaining the card data comprises entering data into the local device using an alphanumeric keypad.

7. The method according to claim 6, wherein the data entered includes a user-specified password.

8. The method according to claim 7, further including assigning the password to the wallet entry.

9. The method according to claim 8, including completing an online transaction using a previously created wallet entry.

10. The method according to claim 9, including entering the password associated with the wallet entry using an input device, and transmitting the password to the remote server to authenticate use of the previously created wallet entry.

11. The method according to claim 10, including converting the password into a keyed-hash message authentication code prior to transmission to the remote server.

12. The method according to claim 11, including combining the password with a transaction total to create the keyed-hash message authentication code.

13. The method according to claim 11, including using the password as a key for creating the keyed-hash message authentication code.

14. The method according to claim 10, wherein the input device is a control unit for the network portal.

15.-25. (canceled)

26. The method according to claim 1, wherein a secure channel is established between the local device and the remote server using session keys.

27. A system for enabling the creation of a wallet entry in a digital wallet, wherein the wallet entry is for use in completing online transactions, and wherein the system comprises:
a network portal arranged to connect to a network;
a local device arranged to associate with the network portal, wherein the local device comprises:
an input module arranged to obtain card data relating to a card;
an encryption module arranged to encrypt the card data; and
a transmission module arranged to transmit the encrypted card data from the local device to a remote server by means of the network portal wherein the remote server is arranged to decrypt the card data and use the card data to create the wallet entry.

28. The system according to claim 27, wherein the network portal is an internet-connectable television.

29. (canceled)

30. The system according to claim 27, comprising an input device arranged to enable a user to input data.

31. The system according to claim 30, wherein the input device is a control unit for the network portal.

32. (canceled)

33. (canceled)

34. A system for completing online transactions, wherein the system comprises:
an internet-connectable television;
a local device arranged to associate with the internet-connectable television, wherein the local device comprises:
an input module arranged to obtain card data relating to a card;
an encryption module arranged to encrypt the card data; and
a transmission module arranged to transmit the encrypted card data from the local device to a remote server by means of the network portal.

35.-39. (canceled)
